(19) United States
(12) Patent Application Publication
(10) Pub. No.: US 2013/0010617 A1
(43) Pub. Date: Jan. 10, 2013

(54) RELATIVE POSITION DETERMINATION OF WIRELESS NETWORK DEVICES

(75) Inventors: Qifan Chen, Shanghai (CN); Youhan Kim, Albany, CA (US); Ning Zhang, Saratoga, CA (US)

(73) Assignee: Qualcomm Atherons, Inc., San Jose, CA (US)

(21) Appl. No.: 13/178,475

(22) Filed: Jul. 7, 2011

(51) Int. Cl. H04W 24/00; H04W 4/02

(52) U.S. Cl. 370/252; 370/328

(57) ABSTRACT

The position of a target wireless device in a wireless communication network can be calculated relative to a predetermined number of reference wireless devices in the wireless communication network to preclude the need for fixed/absolute reference points. The reference wireless devices can be selected based, at least in part, on comparing one or more performance measurements associated with each wireless device against one or more corresponding threshold performance measurements. The position of each of the reference wireless network devices relative to each other is determined based, at least in part, on a distance between each pair of the reference wireless network devices. The relative position of the target wireless network device is determined based, at least in part, on the position of each of the reference wireless network devices relative to each other and a distance between the target wireless network device and each of the reference wireless network devices.

### BACKGROUND

Embodiments of the inventive subject matter generally relate to the field of communication systems and, more particularly, to determining relative position of wireless devices in a wireless communication network.

In some wireless communication networks, the position of multiple wireless devices (e.g., fixed access points, cellular towers, and other reference wireless devices) may be known. The position of a wireless device whose position is unknown can then be estimated based on signals transmitted between the wireless device and the reference wireless devices. However, in some implementations (e.g., in an ad-hoc wireless network), the position of the wireless devices may not be known a priori.

### SUMMARY

Various embodiments for determining the relative position of wireless devices in a wireless communication network are disclosed. In one embodiment, a first reference wireless network device of a plurality of wireless network devices of a wireless communication network determines to calculate a relative position of a target wireless network device of the plurality of wireless network devices. A subset of the plurality of wireless network devices are selected as reference wireless network devices based, at least in part, on determining one or more performance measurements associated with at least the subset of the plurality of wireless network devices. A position of each of the reference wireless network devices relative to each other is determined based, at least in part, on a distance between each pair of the reference wireless network devices. The relative position of the target wireless network device relative to the reference wireless network devices is determined based, at least in part, on the position of each of the reference wireless network devices relative to each other and a distance between the target wireless network device and each of the reference wireless network devices.

### BRIEF DESCRIPTION OF THE DRAWINGS

The present embodiments may be better understood, and numerous objects, features, and advantages made apparent to those skilled in the art by referencing the accompanying drawings.

FIG. 1 is an example block diagram illustrating a mechanism for determining the relative position of a wireless device in a wireless communication network;

FIG. 2 is a flow diagram illustrating example operations for determining the relative position of a wireless device in a wireless communication network;

FIG. 3 is a continuation of FIG. 2 and also illustrates example operations for determining the relative position of a wireless device in a wireless communication network;

FIG. 4 is a flow diagram illustrating a hybrid mechanism for determining the relative position of a wireless device in a wireless communication network;

FIG. 5 is a continuation of FIG. 4 and also depicts a hybrid mechanism for determining the relative position of a wireless device in a wireless communication network; and

FIG. 6 is an example block diagram of one embodiment of an electronic device including a mechanism for determining the relative position of a wireless device in a wireless communication network.

### DESCRIPTION OF EMBODIMENT(S)

The description that follows includes exemplary systems, methods, techniques, instruction sequences, and computer program products that embody techniques of the present inventive subject matter. However, it is understood that the described embodiments may be practiced without these specific details. For instance, although examples refer to mechanisms for determining the relative position of wireless local area network (WLAN) devices, embodiments are not so limited. In other embodiments, the mechanisms for determining the relative position can be executed by other standards and devices (e.g., WiMAX). In other instances, well-known instruction instances, protocols, structures, and techniques have not been shown in detail in order not to obfuscate the description.

The position of wireless devices in a wireless communication network relative to other wireless devices in the wireless communication network (“relative position”) may be desired if the absolute position of the wireless devices and/or a predetermined number of distinct reference points is unknown. As one example, the relative position of each detected player (e.g., using a wireless remote, by facial recognition, etc.) may be desired in a gaming environment. Typically, the relative position of the wireless devices can be determined by minimizing an expression that is a complex function of the unknown positions of the wireless devices and the distance between each pair of wireless devices. Although parametric techniques such as Bayesian estimation techniques and maximal likelihood (ML) estimation techniques can be employed to determine the relative position of the wireless devices, the complexity of the solution increases exponentially as the number of wireless devices in the wireless communication network increases. This can result in an increase in the number of computations, processing time, and processing resources associated with determining the relative position of the wireless devices.

In some embodiments, functionality can be implemented to determine the relative position of a target wireless device of a communication network based, at least in part, on the relative position of a predetermined number of reference wireless devices in the communication network. The predetermined number of reference wireless devices relative to which the position of the target wireless device is determined are herein referred to as “anchor stations.” The anchor stations can be selected from the available wireless devices of the communication network based on performance measurements (e.g., signal strength) associated with the wireless devices, line of sight visibility, the type of wireless device (e.g., whether the wireless device is an access point), protocols/functionality implemented by the wireless devices, and/or a combination thereof. The relative position of the selected anchor stations with respect to each other can be determined based, at least in part, on the distance between each pair of the selected anchor stations. The relative position of the target wireless devices (e.g., one or more of the other wireless devices in the wireless communication network that are not the anchor stations) can be determined based, at least in part, on the relative position of the anchor stations and the distance between the target wireless device and each of the anchor stations. Such a mechanism for determining the relative position can preclude the need for fixed/absolute reference points. Moreover, an initial determination of the relative position of only a subset of the available wireless devices (e.g., three anchor stations for determining 2-dimensional position) can minimize the complexity associated with determining the relative position of all the wireless devices in the communication network.

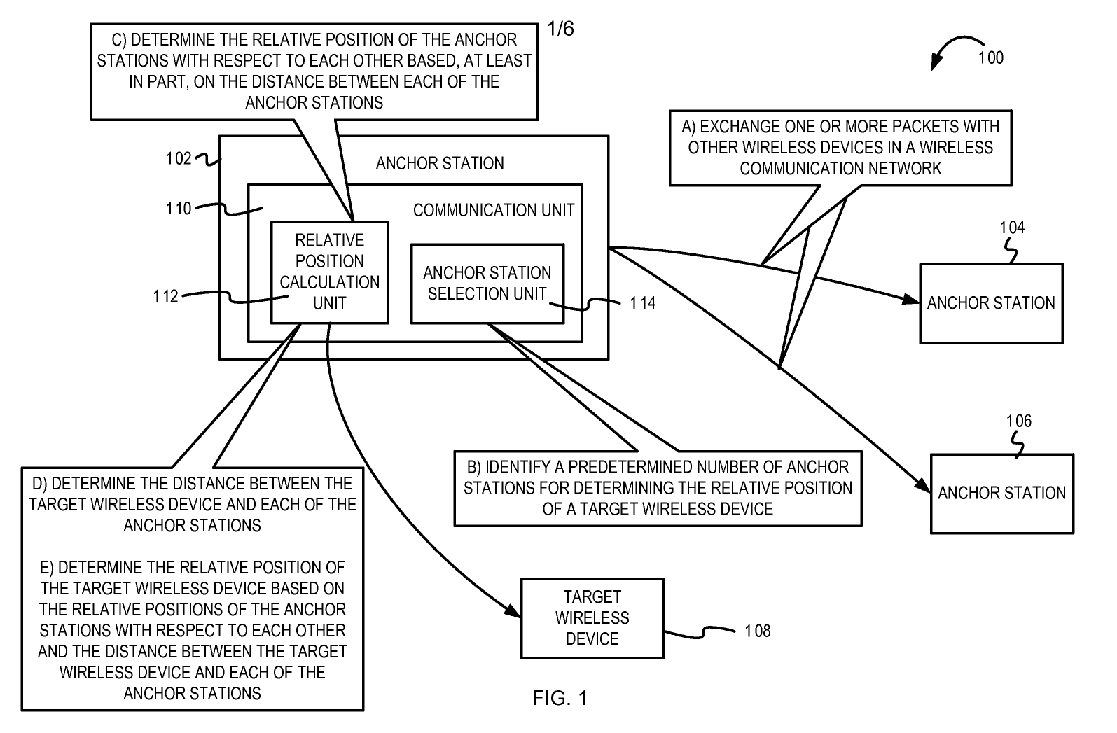

FIG. 1 is an example block diagram illustrating a mechanism for determining the relative position of a wireless device in a wireless communication network 100. The wireless communication network 100 comprises four wireless devices 102, 104, 106, and 108. The wireless device 102 comprises a communication unit 110. The communication unit 110 comprises a relative position calculation unit 112 and an anchor station selection unit 114. Although not depicted in FIG. 1, in some implementations, one or more of the wireless devices 104, 106, and 108 can also comprise a relative position calculation unit and an anchor station selection unit. In some implementations, all of the WLAN devices can comprise functionality to determine the relative position of other WLAN devices. For example, all of the WLAN devices in an ad-hoc WLAN network can comprise functionality to determine the relative position of other WLAN devices in the ad-hoc WLAN network. In other implementations, only one (or a subset) of the wireless devices of the wireless communication network 100 may comprise functionality for determining the relative position of other wireless devices. For example, in an infrastructure WLAN network (or a peer-to-peer (P2P) WLAN network), only an access point (or P2P group owner) may comprise functionality for determining the relative position of the other wireless devices in the wireless communication network 100. As will further be described below in stages A-E, the relative position of one of the wireless devices (“target wireless device”) in the wireless communication network 100 can be determined based, at least in part, on knowledge of the relative position of a predetermined number of reference wireless devices (“anchor stations”).

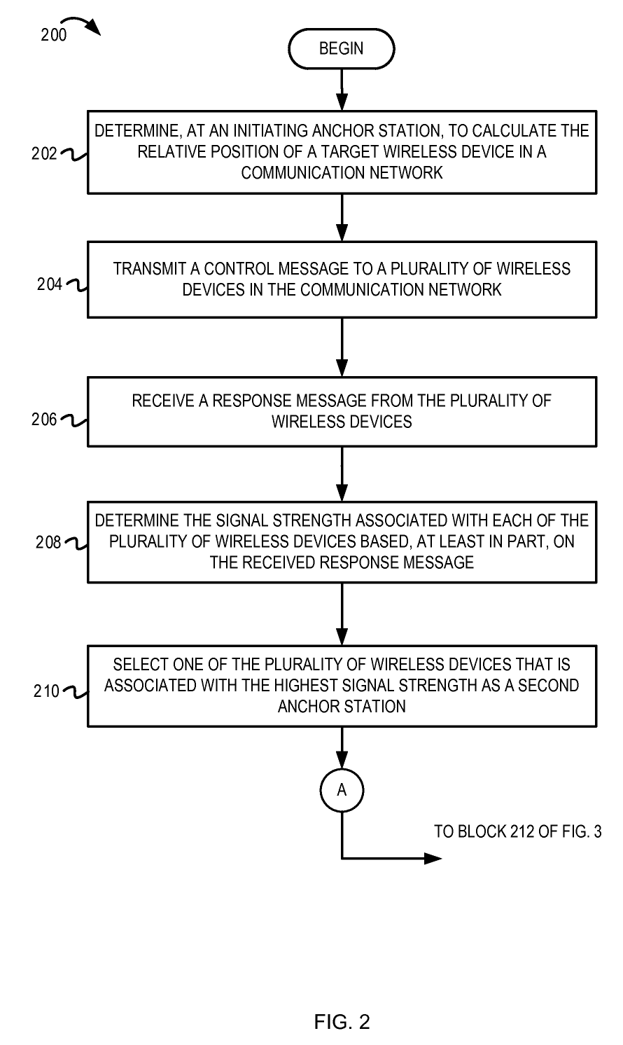

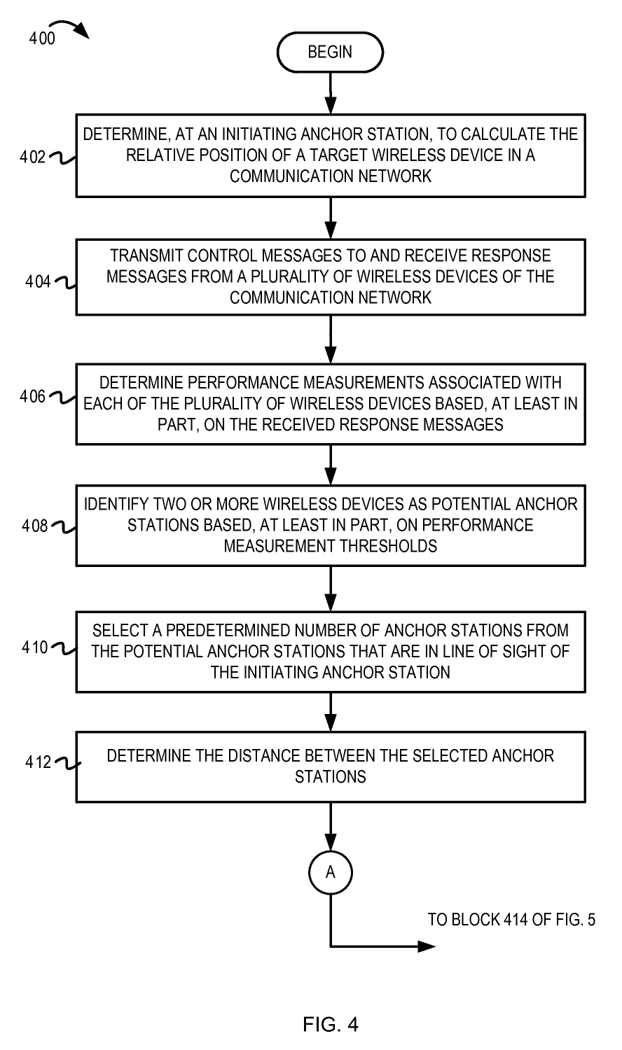

At stage A, the anchor station selection unit 114 of the wireless device 102 exchanges one or more packets with other wireless device 104, 106, and 108 in the wireless communication network 100. In some implementations, the anchor station selection unit 114 may designate the wireless device 102 as one of the anchor stations. The wireless device 102, therefore, may also be referred to as an “initiating anchor station.” As will be described below in FIG. 2, the anchor station selection unit 114 can transmit control messages to the wireless devices 104, 106, and 108 and can receive response messages from the wireless devices 104, 106, and 108. The anchor station selection unit 114 can then select the anchor stations based, at least in part, on the received response messages, as will be described below in stage B and in FIGS. 2 and 4.

At stage B, the anchor station selection unit 114 identifies a predetermined number of anchor stations for determining the relative position of a target client station. In some implementations, as described above, the wireless device 102 may be selected as one of the anchor stations. In one implementation, for each of the wireless devices 104, 106, and 108, the anchor station selection unit 114 can calculate performance measurements associated with the communication channel between the initiating anchor station 102 and each of the wireless devices. For example, the anchor station selection unit 114 can calculate the received signal strength indicator (RSSI), the packet error rate (PER), and other suitable performance measurements based on the response message received from the wireless device 104. As will be further described below in FIGS. 2 and 4, the anchor station selection unit 114 can select the predetermined number of anchor stations based on comparing the performance measurements associated with the wireless devices against performance measurement thresholds. In the example of FIG. 1, the anchor station selection unit 114 designates the wireless devices 102, 104, and 106 as anchor stations.

The anchor station selection unit 114 can select any suitable number of anchor stations depending on the desired accuracy, desired redundancy, the dimension of position coordinates, and other such factors. In one example, the anchor station selection unit 114 can determine that at least three anchor stations should be selected to subsequently determine two-dimensional (2D) position coordinates (e.g., X and Y coordinates) of the wireless devices. Therefore, in addition to the initiating anchor station 102, the anchor station selection unit 114 can select at least two other anchor stations. As another example, the anchor station selection unit 114 can determine that at least four anchor stations should be selected to subsequently determine three-dimensional (3D) position coordinates (e.g., X, Y, and Z coordinates) of the wireless devices. Therefore, in addition to the initiating anchor station 102, the anchor station selection unit 114 can select at least three other anchor stations.

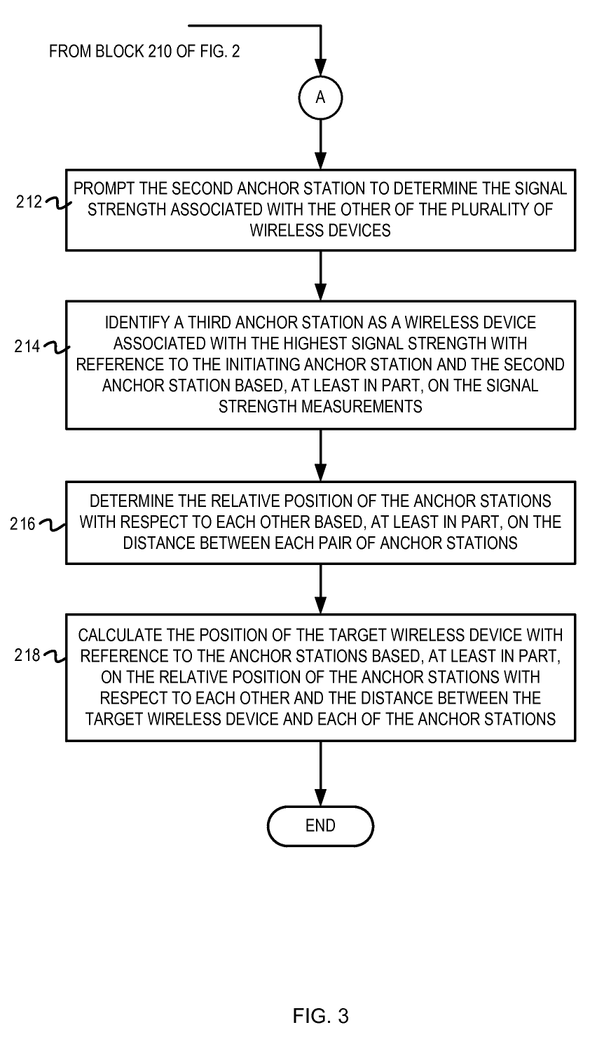

At stage C, the relative position calculation unit 112 determines the relative position of the anchor stations 102, 104, and 106 with respect to each other based, at least in part, on the distance between each of the anchor stations. In some implementations, the relative position calculation unit 112 can determine a round-trip delay between each pair of the anchor stations 102, 104, and 106. The round trip delay can be calculated as the difference between the time instant at which the control message was transmitted to a destination device and the time instant at which the corresponding response message was received from the destination device. The relative position calculation unit 112 can determine the distance between each pair of anchor stations 102, 104, and 106 based on the calculated round trip delay. In some implementations, the distance between each pair of anchor stations 102, 104, and 106 can be calculated using Eq. 8, as described below in block 406 of FIG. 4. Then, the relative position calculation unit 112 can determine the position of the anchor stations 102, 104, and 106 relative to each other based on the distance between each pair of anchor stations 102, 104, and 106, as will be described below in FIGS. 2-3.

At stage D, the relative position calculation unit 112 determines the distance between the target wireless device 108 and each of the anchor stations 102, 104, and 106. The relative position calculation unit 112 can determine the distance between the initiating anchor station 102 and the target wireless device 108 based on the round trip delay between the initiating anchor station 102 and the target wireless device 108 (e.g., as described below in block 406 of FIG. 4). The relative position calculation unit 112 can cause the anchor stations 104 and 106 to similarly determine and report their respective distance to the target wireless device 108.

At stage E, the relative position calculation unit 112 determines the relative position of the target wireless device 108 based on the relative positions of the anchor stations with respect to each other and the distance between the target wireless device 108 and each of the anchor stations. As will be further described in FIG. 3, the relative position calculation unit 112 can calculate the position of the target wireless device 108 relative to the anchor stations 102, 104, and 106 based on the relative positions of the anchor stations (determined at stage C) and based on the distance between the target wireless device 108 and each of the anchor stations (determined at stage D).

FIG. 2 and FIG. 3 depict a flow diagram (“flow”) 200 illustrating example operations for determining the relative position of a wireless device in a wireless communication network. The flow 200 begins at block 202 in FIG. 2.

At block 202, an initiating anchor station determines to calculate the relative position of a target wireless device in a communication network. With reference to the example of FIG. 1, the initiating anchor station 102 of the wireless communication network 100 can determine to calculate the relative position of the target wireless device 108. In some implementations, the initiating anchor station 102 can be an access point that is programmed to determine the relative position of wireless devices in its wireless communication network. In another implementation, the initiating anchor station 102 can be a wireless device that is programmed to determine the relative position of other wireless devices in an ad-hoc wireless communication network. In another implementation, the initiating anchor station 102 can be a P2P group owner (P2PGO) that is programmed to determine the relative position of other wireless devices in a P2P communication network. The relative position of the target wireless device 108 can be determined in response to detecting multiple wireless devices in the wireless communication network 100, in response to a user request, in response to a trigger/request from another application/device, etc. For example, in a gaming environment, a gaming console may execute operations to determine the relative position of one or more players playing a game. The flow continues at block 204.

At block 204, a control message is transmitted to a plurality of wireless devices of the communication network. For example, the anchor station selection unit 114 can transmit a control message to the wireless devices 104, 106, and 108 of the communication network 100. In some implementations, in addition to an identifier of the initiating anchor station 102 and an identifier of the destination wireless device 104, the control message can comprise a predetermined payload (e.g., a predetermined combination of symbols). In other implementations, the control message may not comprise any payload (e.g., a NULL payload). The anchor station selection unit 114 can also record the time instant at which the control message was transmitted to each of the wireless devices 104, 106, and 108. The flow continues at block 206.

At block 206, a response message is received from the plurality of wireless devices. For example, the anchor station selection unit 114 can receive a response message from the wireless devices 104, 106, and 108. In some implementations, the response message can be a WLAN acknowledgement (ACK) message that indicates receipt of the control message. In other implementations, the response message can be any suitable message that is generated in response to the control message. In some implementations, the response message can comprise a predetermined payload (e.g., a predetermined combination of symbols) that is different from the payload of the control message. In other implementations, the response message may comprise the same payload as that of the control message. In other implementations, the response message may not comprise any payload (e.g., a NULL payload). The anchor station selection unit 114 can also record the time instant at which the response message was received from each of the wireless devices 104, 106, and 108. In some implementations, if the anchor station selection unit 114 does not receive a response message from the wireless device 104 within a predetermined response time interval, the anchor station selection unit 114 can retransmit the control message to the wireless device 104 (e.g., until a predetermined number of retransmission attempts expire, until a predetermined retransmission time interval expires, etc.). In another implementation, if the anchor station selection unit 114 does not receive a response message from the wireless device 104 within a predetermined response time interval, the anchor station selection unit 114 can determine not to take the wireless device 104 into consideration while selecting the anchor stations. The flow continues at block 208.

At block 208, the signal strength associated with each of the plurality of wireless devices is determined based, at least in part, on the received response message. For example, the anchor station selection unit 114 can determine the signal strength associated with the wireless devices 104, 106, and 108 based, at least in part, on the response messages received at block 206. To determine the signal strength associated with the wireless device 104, the anchor station selection unit 114 can calculate the received signal strength indicator (RSSI) of the received signal that comprises the response message from the wireless device 104. It is noted that in some implementations, the anchor station selection unit 114 may determine the amplitude, the square of the amplitude, the energy, or other suitable indication of the signal strength associated with each of the plurality of wireless devices 104, 106, and 108. The flow continues at block 210.

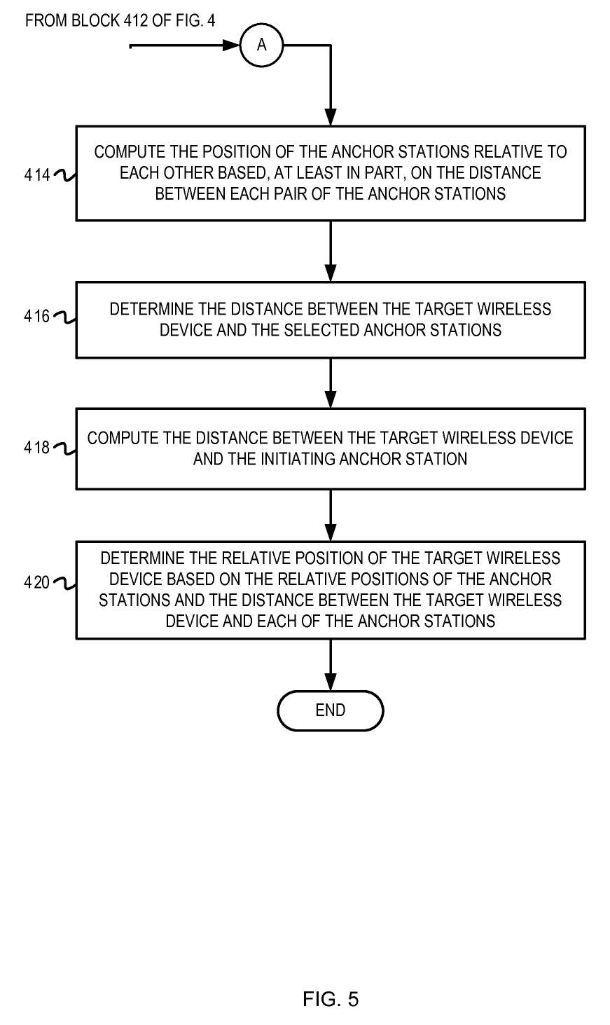

At block 210, one of the plurality of wireless devices that is associated with the highest signal strength is selected as a second anchor station. For example, the anchor station selection unit 114 can select the second anchor station as the wireless device that is associated with the highest signal strength because distance measurement accuracy (and consequently position estimation accuracy) is directly proportional to the signal strength. With reference to FIG. 1, the anchor station selection unit 114 can select the wireless device 104 as the second anchor station if the wireless device 104 is associated with the highest signal strength (e.g., RSSI). The anchor station selection unit 114 can notify the relative position calculation unit 112 that the wireless device 104 is the second anchor station. It is noted that in some implementations as will further be described in FIGS. 4-5, the anchor station selection unit 114 may discard the wireless device 104 (e.g., may not select the wireless device 104 as an anchor station) if the RSSI associated with the wireless device 104 is less than a predetermined RSSI threshold to minimize errors due to poor measurement accuracy. The flow continues at block 212 in FIG. 3.

At block 212 in FIG. 3, the second anchor station is prompted to determine the signal strength associated with the other of the plurality of wireless devices. For example, the anchor station selection unit 114 can prompt the second anchor station 104 to determine the signal strength associated with the wireless devices 106 and 108 with reference to the second anchor station 104. The second anchor station can transmit control messages to and receive response messages from the wireless devices 106 and 108. The second anchor station 104 can then calculate the signal strength associated with the wireless devices 106 and 108 with reference to the second anchor station 104 based on the received response messages. For example, the second anchor station 104 can determine the RSSI of the received signals that comprise the response messages from the wireless devices 106 and 108. In some implementations, the second anchor station 104 can also record the time instants at which the control messages were transmitted to the wireless devices 106 and 108, and the time instants at which the response messages were received from the wireless devices 106 and 108. The anchor station selection unit 114 can receive (from the second anchor station) an indication of the signal strength associated with the wireless devices 106 and 108, as calculated by the second anchor station 104. The flow continues at block 214.

At block 214, a third anchor station is identified as a wireless device associated with the highest signal strength with reference to the initiating anchor station and the second anchor station based, at least in part, on the signal strength measurements. In one implementation, the second anchor station 104 can provide an indication of the signal strength associated with the wireless devices 106 and 108, as determined with reference to the second anchor station 104. In another implementation, the second anchor station 104 can provide an indication of the signal strength associated with a subset of the wireless devices (e.g., if the signal strength is greater than a predetermined threshold). The anchor station selection unit 114 can then select the third anchor station that is associated with the highest signal strength with reference to the initiating anchor station 102 and the second anchor station 104. In one example, a first minimum of the RSSI associated with one wireless device 106 with reference to the anchor station 102 and the RSSI associated with the wireless device 106 with reference to the anchor station 104 is determined. A second minimum of the RSSI associated with another wireless device 108 with reference to the anchor station 102 and the RSSI associated with the wireless device 108 with reference to the anchor station 104 is determined. If the first minimum is greater than the second minimum, the wireless device 106 is selected as the third anchor station. Otherwise, the wireless device 108 is selected as the third anchor station. This mechanism for selecting the third anchor station is mathematically illustrated by expression Exp. 1, where STA1 and STA2 represent the two anchor stations. If the expression Exp. 1 is valid, then STA N is chosen as the third anchor station. If the expression Exp. 1 is not valid, then STA K is chosen as the third anchor station. The flow continues at block 216.

min(RSSI_{STA1,STA N},RSSI_{STA2,STA N})>min(RSSI_{STA1,STA K},RSSI_{STA2,STA k}) Exp. 1

At block 216, the relative position of the anchor stations with respect to each other is determined based, at least in part, on the distance between each pair of anchor stations. For example, the relative position calculation unit 112 can determine the relative position of the anchor stations 102, 104, and 106 based, at least in part, on the distance between each pair of anchor stations 102, 104, and 106. The relative position calculation unit 112 can determine the distance between the initiating anchor station 102 and the anchor stations 104 and 106 based on the time instants at which control messages were transmitted to the anchor stations 104 and 106 (determined at block 204), and the time instants at which response message were received from the anchor stations 104 and 106 (determined at block 206). In some implementations, the distance between the initiating anchor station 102 and the anchor stations 104 and 106 can be calculated using Eq. 8, as described below in block 406 of FIG. 4. The relative position calculation unit 112 can cause the anchor station 104 to determine and report the distance to the anchor station 106. The anchor station 104 can determine the distance to the anchor station 106 based on the time instants at which the anchor station 104 transmitted the control message to and received the response message from the anchor station 106 (determined at block 212). In some implementations, the relative position calculation unit 112 can also prompt the anchor station 106 to calculate and report its distance to the anchor station 104. The relative position calculation unit 112 can calculate the average of the two reported distances to determine the distance between the anchor stations 104 and 106. After the distance between each pair of anchor stations 102, 104, and 106 is determined, the relative position calculation unit 112 can determine the position of the anchor stations relative to each other.

In one implementation, if the distance between the initiating anchor station 102 and the second anchor station 104 is d_{1,2}, the position coordinates (x₁, y₁) of the initiating anchor station 102 and the position coordinates (x₂, y₂) of the second anchor station 104 can be assigned in accordance with Exp. 2. As depicted below, the initiating anchor station 102 can be selected as the origin of a coordinate system and the line joining the initiating anchor station 102 and the second anchor station 104 can be selected as one of the axes of the coordinate system.

(x₁,y₁)=(0,0) and (x₂,y₂)=(0,d_{1,2}) Exp. 2

If d_{1,3} represents the distance between the initiating anchor station 102 and the third anchor station 106 and d_{2,3} represents the distance between the second anchor station 104 and the third anchor station 106, then the position of the third anchor station 106 can be calculated in accordance with Eqs., 3a-5. First, the relative position calculation unit 112 can compute a set of intermediate positioning results (e.g., for easier/faster processing) as depicted below in Eqs. 3a-3d.

$$\begin{matrix}z = \frac{{d}_{1 , 3}^{2} - {d}_{2 , 3}^{2} - {x}_{1}^{2} + {x}_{2}^{2} - {y}_{1}^{2} + {y}_{2}^{2}}{2 ( {y}_{2} - {y}_{1} )} & Eq . 3 a \\ a = 1 + \frac{{( {x}_{2} - {x}_{1} )}^{2}}{{( {y}_{2} - {y}_{1} )}^{2}} & Eq . 3 b \\ b = \frac{- 2 {x}_{1} - 2 ( {x}_{2} - {x}_{1} ) ( z - {y}_{1} )}{( {y}_{2} - {y}_{1} )} & Eq . 3 c \\ c = {x}_{1}^{2} + {( z - {y}_{1} )}^{2} - {d}_{1 , 3}^{2} & Eq . 3 d\end{matrix}$$

Next, the relative position calculation unit 112 can then determine whether the condition b²−4ac≧0 is satisfied. Depending on whether this condition is satisfied, the relative position calculation unit 112 can determine the position coordinates (x₃, y₃) of the third anchor station 106. Calculation of the X-coordinate of the third anchor station 106 is illustrated in Eqs. 4a and 4b, while calculation of the Y-coordinate is illustrated in Eq. 5.

$$\begin{matrix}\begin{matrix}If {b}^{2} - 4 ac \geq 0 ; & then {x}_{3} = \frac{- b + sqrt ( {b}^{2} - 4 ac )}{2 a}\end{matrix} & Eq . 4 a \\ \begin{matrix}If {b}^{2} - 4 ac < 0 ; & then {x}_{3} = \frac{- b}{2 a}\end{matrix} & Eq . 4 b \\ {y}_{3} = z - \frac{( {x}_{2} - {x}_{1} )}{( {y}_{2} - {y}_{1} )} * {x}_{3} & Eq . 5\end{matrix}$$

It is noted that in other implementations, any suitable reference position (e.g., an object or device with a fixed position) can be selected as the origin and likewise, any suitable coordinate axes can be selected. In other implementations, other suitable techniques can be employed to determine the position of the anchor stations with reference to each other. For example, the position coordinates of the anchor stations can be determined such that the difference between the distance computed using the position coordinates and the previously measured distance is minimized. In other words, the position coordinates of the anchor stations can be determined by solving the equation described by Eq. 6. The flow continues at block 218.

$$\{ ( {x}_{1} , {y}_{1} ) , ( {x}_{2} , {y}_{2} ) , ( {x}_{3} , {y}_{3} ) \} = arg {min}_{( {x}_{1} , {y}_{1} ) , ( {x}_{2} , {y}_{2} ) , ( {x}_{3} , {y}_{3} )} {\sum }_{i = 1}^{3} {\sum }_{{j = 1}_{j \neq i}}^{3} \sqrt{{( {x}_{j} - {x}_{i} )}^{2} + {( {y}_{j} - {y}_{i} )}^{2}} - {d}_{i , j} \qquad Eq . 6$$

At block 218, the position of the target wireless device is calculated with reference to the anchor stations based, at least in part, on the relative position of the anchor stations with respect to each other and the distance between the target wireless device and each of the anchor stations. In some implementations, the relative position calculation unit 112 can determine the distance between the initiating anchor station 102 and the target wireless device 108 (e.g., as described below in block 406 of FIG. 4). The relative position calculation unit 112 can also cause the other anchor stations 104 and 106 to determine their respective distances to the target wireless device 108. The relative position calculation unit 112 can then employ any suitable positioning mechanisms to determine the position coordinates of the target wireless device 108 with reference to the anchor stations 102, 104, and 106 based on the relative position of the anchor stations (determined at block 216) and based on the distance between the target wireless device 108 and each of the anchor stations 102, 104, and 106. For example, the relative position calculation unit 112 can use GPS mechanisms (e.g., triangulation) to determine the position coordinates of the target wireless device 108 with reference to the anchor stations 102, 104, and 106. If i is a counter for the anchor stations 102, 104, and 106, N is the number of target anchor stations, (x₁, y₁) represents the position coordinates of the anchor stations, and d_{k,i} is the distance between i^{th} anchor station and the k^{th} wireless device (e.g., the target wireless device 108), the coordinates (xₖ, yₖ) of the k^{th} wireless device can be calculated in accordance with Eq. 7. As another example, the relative position calculation unit 112 can use Taylor-series based mechanisms to determine the position coordinates of the target wireless device 108 with reference to the anchor stations 102, 104, and 106. From block 218, the flow ends.

$$( {x}_{k} , {y}_{k} ) = arg {min}_{( {x}_{k} , {y}_{k} )} {\sum }_{i = 1}^{N} \sqrt{{( {x}_{k} - {x}_{i} )}^{2} + {( {y}_{k} - {y}_{i} )}^{2}} - {d}_{k , i} \qquad Eq . 7$$

It is noted that although FIGS. 2-3 depicts operations for selecting the anchor stations based on the signal strength between the wireless devices in the wireless communication network 100, embodiments are not so limited. In other embodiments, a combination of performance measurements can be employed to select the anchor stations, as will be described below in FIGS. 4-5.

FIG. 4 and FIG. 5 depict a flow diagram 400 illustrating a hybrid mechanism for determining the relative position of a wireless device in a wireless communication network. The flow 400 begins at block 402 in FIG. 4.

At block 402, an initiating anchor station determines to calculate the relative position of a target wireless device in a communication network. With reference to the example of FIG. 1, the initiating anchor station 102 can determine to calculate the relative position of the target wireless device 108. The flow continues at block 404.

At block 404, control messages are transmitted to and response messages are received from a plurality of wireless devices of the communication network. For example, the anchor station selection unit 114 can transmit one or more control messages to the wireless devices 104, 106, and 108 (as described above at block 304 of FIG. 3). The anchor station selection unit 114 can also receive response messages (e.g., a WLAN ACK message) from the wireless devices 104, 106, and 108 (as described above at block 306 of FIG. 3). The flow continues at block 406.

At block 406, performance measurements associated with each of the plurality of wireless devices are determined based, at least in part, on the received response messages. For example, the anchor station selection unit 114 can determine the performance measurements associated with the wireless devices 104, 106, and 108. The performance measurements can comprise the RSSI, the PER, other suitable measures of signal strength (e.g., square of the amplitude of a received signal), other suitable measures of the error (e.g., bit error rate), etc. In some implementations, the anchor station selection unit 114 can also calculate the round trip delay or the elapsed time between transmitting the control message to the wireless device and receiving the response message from the wireless device. If Δ_{i,j}represents the round trip delay between the i^{th} and the j^{th} wireless devices (e.g., between the initiating anchor station 102 and another wireless device) and c represents the speed of light, then the distance (d_{i,j}) between the i^{th} and there wireless devices (e.g., between the initiating anchor station 102 and another wireless device) can be calculated in accordance with Eq. 8.

$${d}_{i , j} = \frac{c . {Δ}_{i , j}}{2} \qquad Eq . 8$$

It is noted that in other implementations, the anchor station selection unit 114 can employ other suitable mechanisms for computing the round trip delay and the distance between the initiating anchor station 102 and the other wireless devices. The flow continues at block 408.

At block 408, two or more wireless devices are identified as potential anchor stations based, at least in part, on performance measurement thresholds. For example, the anchor station selection unit 114 can compare the performance measurements associated with the wireless devices 104, 106, and 108 against corresponding performance measurement thresholds to minimize distance measurement errors and consequently to improve position estimation accuracy. If the performance measurements associated with the wireless devices 104, 106, and 108 are in accordance with the performance measurement thresholds, the anchor station selection unit 114 can designate the wireless devices 104, 106, and 108 as potential anchor stations. For example, the anchor station selection unit 114 can compare the RSSI associated with the wireless device 104 against a predetermined RSSI threshold (e.g., −60 dBm). The anchor station selection unit 114 can select the wireless device 104 as a potential anchor station if the RSSI associated with the wireless device 104 is greater than the predetermined RSSI threshold. As another example, the anchor station selection unit 114 can compare the PER associated with the wireless device 104 against a predetermined PER threshold (e.g., 0.5%). The anchor station selection unit 114 can select the wireless device 104 as a potential anchor station if the PER associated with the wireless device 104 is less than the predetermined PER threshold. As another example, the anchor station selection unit 114 can compare a combination of multiple performance measurements (e.g., a weighted combination of the RSSI and the PER) associated with the wireless device 104 against a predetermined performance threshold to determine whether to select the wireless device 104 as a potential anchor station. As another example, the anchor station selection unit 114 can compare multiple performance measurements (e.g., both the RSSI and the PER) associated with the wireless device 104 against the corresponding performance measurement threshold (e.g., the RSSI threshold and the PER threshold respectively). In some implementations, the anchor station selection unit 114 can select the wireless device 104 as a potential anchor station if all of the multiple performance measurements are in accordance with their respective performance measurement thresholds. In another implementation, the anchor station selection unit 114 can select the wireless device 104 as a potential anchor station if a predetermined number of the multiple performance measurements are in accordance with their respective performance measurement thresholds. After the potential anchor stations are identified, the flow continues at block 410.

At block 410, a predetermined number of anchor stations that are in line of sight of the initiating anchor station are selected from the potential anchor stations. For example, the anchor station selection unit 114 can identify the predetermined number of anchor stations that are in line of sight of the initiating anchor station 102 from the potential anchor stations determined at block 408. In one implementation, the anchor station selection unit 114 can employ a heuristic method to determine line of sight (LOS) visibility by analyzing the frequency response (or the delay spread or the coherence bandwidth) of the communication channel between the initiating anchor station 102 and each of the potential anchor stations. In a LOS path, a signal transmitted by the initiating anchor station 102 is received at the potential anchor station via a straight line signal path between the initiating anchor station 102 and the potential anchor station. In a non-line of sight (NLOS) path, a signal transmitted by the initiating anchor station 102 is received at the potential anchor station after being reflected from one or more other objects. Because the transmitted signal can undergo multiple reflections in the NLOS path, the NLOS path can comprise frequency selective channels. Also, a signal received via the LOS path typically associated with a higher accuracy (e.g., lower PER) as compared to a signal received via the NLOS path. Although the signal received via the LOS path can also undergo signal reflections (resulting in frequency selective channels), it can be heuristically assumed that a communication channel with a flat frequency response is more likely to be a LOS channel. Therefore, the potential anchor stations associated with the most flat frequency response (or the smallest time domain delay spread) can be selected as the anchor stations. With reference to FIG. 1, if the frequency response of the communication channel between the initiating anchor station 102 and the potential anchor station 104 is flat, this can indicate that the potential anchor station 104 is in line of sight of the initiating anchor station 102. Consequently, the anchor station selection unit 114 can designate the potential anchor station 104 as an anchor station.

As another example, the anchor station selection unit 114 can analyze the energy associated with the first signal received at the initiating anchor station 102 from a potential anchor station 104. Because the LOS path is the shortest path between the initiating anchor station 102 and the potential anchor station 104, the first received signal may be associated with the LOS path if the LOS path exists. The anchor station selection unit 114 can measure the energy of each of the signals received via each signal path between the initiating anchor station 102 and the potential anchor station 104. For each of the potential anchor stations, the anchor station selection unit 114 can compare the energy associated with the first received signal against the energy of the subsequently received signals. If the energy associated with the first received signal is substantially higher (e.g., greater by a predetermined energy threshold) than the energy of the subsequently received signals, this can indicate that the potential anchor station 104 is in line of sight of the initiating anchor station 102. Consequently, the anchor station selection unit 114 can designate the potential anchor station 104 as an anchor station.

It is noted that any suitable number of anchor stations can be selected from the list of potential anchor stations based on line of sight visibility to the initiating anchor station 102. In some embodiments, if all the potential anchor stations are in line of sight of the initiating anchor station 102, the predetermined number of potential anchor stations with best performance measurements (e.g., with the highest RSSI, with the lowest PER, or a combination thereof) can be designated as the anchor stations. In other embodiments, if all the potential anchor stations are in line of sight of the initiating anchor station 102, all of the potential anchor stations may be designated as anchor stations to improve accuracy in estimating the position of the target wireless device 108. Furthermore, it is noted that in other embodiments the anchor stations may be selected based on PER only, or based on LOS only, or based on other combinations of performance measurements, as will be further described below. After a predetermined number of anchor stations are identified, the flow continues at block 412.

At block 412, the distance between the selected anchor stations is determined. For example, after the wireless devices 104 and 106 are selected as anchor stations, the relative position calculation unit 112 can determine the distance between the anchor stations 104 and 106. In one implementation, the relative position calculation unit 112 can prompt one of the anchor stations (e.g., the anchor station 104) to determine and report its distance to the other anchor station 106. In another implementation, the relative position calculation unit 112 can also prompt the anchor station 106 to calculate and report its distance to the anchor station 104. The relative position calculation unit 112 can calculate the average of the two reported distances to determine the distance between the anchor stations 104 and 106. The flow then continues at block 414 in FIG. 5.

At block 414 in FIG. 5, the position of the anchor stations relative to each other is computed based, at least in part, on the distance between each pair of the anchor stations. For example, the relative position calculation unit 112 can compute the relative position of the anchor stations 102, 104, and 106 with reference to each other based on the distance between each pair of the anchor stations 102, 104, and 106, as described above in block 216 of FIG. 3. The flow continues at block 416.

At block 416, the distance between the target wireless device and the two selected anchor stations is determined. For example, the relative position calculation unit 112 can determine the distance between the target wireless device 108 and the anchor stations 104 and 106 selected at block 410. The relative position calculation unit 112 can cause the selected anchor stations 104 and 106 to measure their respective distance to the target wireless device 108. As described above, each of the selected anchor stations 104 and 106 can transmit a control message to the target wireless device 108, receive a response message from the target wireless device 108, and measure the round trip delay. The distance between the target wireless device 108 and each of the selected anchor stations 104 and 106 can be determined based on the round trip delay as depicted above in Eq. 8. The selected anchor stations 104 and 106 can provide (e.g., to the relative position calculation unit 112) an indication of their respective distance to the target wireless device 108. The flow continues at block 418.

At block 418, the distance between the target wireless device and the initiating anchor station is computed. In one implementation, as described above, the relative position calculation unit 112 can calculate the distance to the target wireless device 108 based on the calculated round trip delay as depicted in Eq. 8. It is noted that in some embodiments, the relative position calculation unit 112 may determine the distance to the target wireless device 108 as part of the performance measurements (calculated at block 406). In this embodiment, the relative position calculation unit 112 may not recalculate the distance to the target wireless device 108 at block 418. The flow continues at block 420.

At block 420, the relative position of the target wireless device is determined based on the relative positions of the anchor stations and the distance between the target wireless device and each of the anchor stations. Based on the relative position of the anchor stations (e.g., at least three anchor stations in the case of 2D positioning, at least four anchor stations in the case of 3D positioning) with respect to each other, the relative position calculation unit 112 can calculate the position of the other wireless devices (e.g., the target wireless device 108) in the wireless communication network 100 relative to the anchor stations 102, 104, and 106. In some implementations, the relative position calculation unit 112 can employ GPS techniques to determine the relative position of the target wireless device 108, as described above in block 218 of FIG. 3. In other examples, the relative position calculation unit 112 can employ any suitable positioning mechanisms (e.g., Taylor series based mechanisms) to determine the location of the target wireless device 108 relative to the anchor stations 102, 104, and 106. From block 420, the flow ends.

It should be understood that FIGS. 1-5 are examples meant to aid in understanding embodiments and should not be used to limit embodiments or limit scope of the claims. Embodiments may comprise additional circuit components, different circuit components, and/or may perform additional operations, fewer operations, operations in a different order, operations in parallel, and some operations differently. In some embodiments, the anchor stations may be selected from the available wireless network devices of the wireless communication network 100 based, at least in part, on the type of wireless network devices, the functionality and protocols implemented by the wireless network devices, the processing capability of the wireless network devices, and other such factors. For example, a gaming environment may comprise a gaming console and the relative position of each detected player in the gaming environment may be desired. In this example, the gaming console can be designated as one of the anchor stations because it is almost always powered on during a game, may have higher signal processing capabilities, and may be able to transmit signals with higher transmit power (enabling better signal detection at other wireless devices in the gaming environment). In some implementations, the gaming environment may also comprise dedicated stations that can act as additional anchor stations. The user may be prompted to place the dedicated stations at far corners of the room so that the dedicated stations (in conjunction with the gaming console) can act as anchor stations to determine the relative position of the players playing the game.

It is noted that although FIGS. 2-3 depict operations for selecting the anchor stations based on the RSSI between the wireless devices in the communication network, embodiments are not so limited. In other embodiments, other suitable performance measurements can be employed to select the anchor stations. For example, the wireless devices that are associated with the lowest PER amongst each other can be selected as the anchor stations. For example, if it is determined that the communication channels between the wireless devices 102 and 104, 102 and 108, 104 and 108 have the lowest PER, the wireless devices 102, 104, and 108 can be selected as anchor stations. In other embodiments, line of sight visibility can be employed to select the anchor stations. As described above in block 410 of FIG. 4, the wireless devices associated with the flattest frequency response (or the smallest time domain delay spread) can be selected as the anchor stations. Furthermore, although FIGS. 4-5 describe operations for selecting the anchor stations based on a combination of the line of sight visibility and the RSSI between the wireless devices, embodiments are not so limited. In other embodiments, other suitable performance measurements (e.g., PER), or a combination of performance measurements can be employed in conjunction with line of sight visibility to select the anchor stations. Furthermore, FIGS. 4 and 5 describe operations for first selecting the potential anchor stations based on analyzing the performance measurements and then selecting the anchor stations based on determining line of sight visibility with the initiating anchor station 102. However, embodiments are not so limited. In other embodiments, the wireless devices can be filtered to select the anchor stations by analyzing the wireless devices based on any suitable number of metrics (e.g., RSSI, PER, device type, and/or line of sight visibility, etc.), in any suitable order, and analyzing the wireless devices based on any suitable combination of the metrics. For example, the potential anchor stations can be selected based on line of sight visibility and the anchor stations can be selected from the potential anchor stations based on analyzing the PER, the device type, and/or the RSSI.

It is noted that although FIGS. 1-5 describe operations for selecting three anchor stations and calculating the position of a target wireless device relative to the three anchor stations, embodiments are not so limited. In other embodiments, any suitable number of anchor stations can be selected. For example, at least four anchor stations may be selected if 3D position coordinates of the wireless devices are to be determined. Although the Figures describe the anchor stations being selected such that the RSSI between each pair of the anchor stations is high, in some embodiments, if the RSSI between all the anchor stations is very high (e.g., greater than a predetermined maximum RSSI threshold), this may indicate that all the anchor stations are located close to each other. This may degrade the position estimation of the target wireless devices relative to the anchor stations. Therefore, in these embodiments, the anchor stations may be selected so that the RSSI between each pair of anchor stations is within a predetermined RSSI range (e.g. −60 dBm to −50 dBm).

Embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments of the inventive subject matter may take the form of a computer program product embodied in any tangible medium of expression having computer usable program code embodied in the medium. The described embodiments may be provided as a computer program product, or software, that may include a machine-readable medium having stored thereon instructions, which may be used to program a computer system (or other electronic device(s)) to perform a process according to embodiments, whether presently described or not, since every conceivable variation is not enumerated herein. A machine-readable medium includes any mechanism for storing or transmitting information in a form (e.g., software, processing application) readable by a machine (e.g., a computer). A machine-readable medium may be a machine-readable storage medium, or a machine-readable signal medium. A machine-readable storage medium may include, for example, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of tangible medium suitable for storing electronic instructions. A machine-readable signal medium may include a propagated data signal with computer readable program code embodied therein, for example, an electrical, optical, acoustical, or other form of propagated signal (e.g., carrier waves, infrared signals, digital signals, etc.). Program code embodied on a machine-readable signal medium may be transmitted using any suitable medium, including, but not limited to, wireline, wireless, optical fiber cable, RF, or other communications medium.

Computer program code for carrying out operations of the embodiments may be written in any combination of one or more programming languages, including an object oriented programming language such as Java, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN), a personal area network (PAN), or a wide area network (WAN), or the connection may be made to an external computer (for example, through the Internet using an Internet Service Provider).

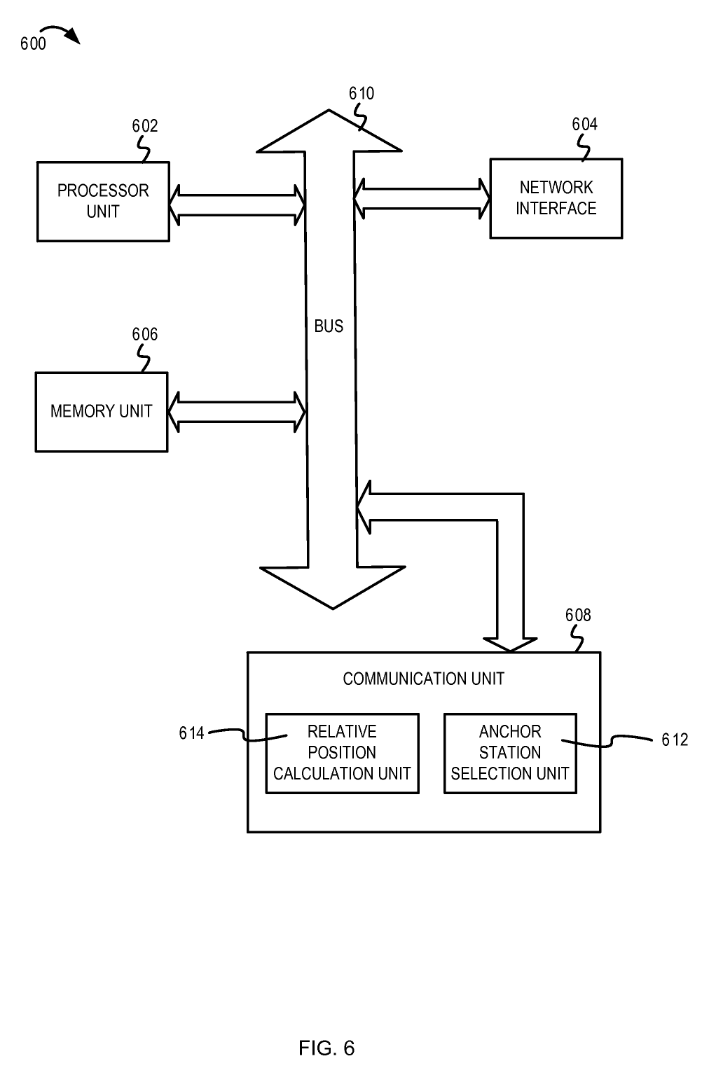

FIG. 6 is a block diagram of one embodiment of an electronic device 600 including a mechanism for determining the relative position of a wireless device in a wireless communication network. In some implementations, the electronic device 600 may be one of a notebook computer, a desktop computer, a tablet computer, a netbook, a mobile phone, a gaming console, a personal digital assistant (PDA), or other electronic systems comprising a WLAN device with wireless communication capabilities. In some implementations, the electronic device 600 can be a standalone WLAN communication device configured to establish a WLAN communication link with one or more WLAN access points. In some implementations, the electronic device 600 can comprise a WLAN access point configured to establish a WLAN communication link with one or more WLAN client stations. The electronic device 600 includes a processor unit 602 (possibly including multiple processors, multiple cores, multiple nodes, and/or implementing multi-threading, etc.). The electronic device 600 includes a memory unit 606. The memory unit 606 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The electronic device 600 also includes a bus 610 (e.g., PCI, ISA, PCI-Express, HyperTransport®, InfiniBand®, NuBus, AHB, AXI, etc.), and network interfaces 604 that include at least one of a wireless network interface (e.g., a WLAN interface, a Bluetooth® interface, a WiMAX interface, a ZigBee® interface, a Wireless USB interface, etc.) and a wired network interface (e.g., an Ethernet interface, etc.).

The electronic device 600 also includes a communication unit 608. The communication unit 608 comprises an anchor station selection unit 612 and a relative position calculation unit 614. The anchor station selection unit 612 in conjunction with the relative position calculation unit 614 can implement functionality to identify multiple anchor stations, determine the relative position of the anchor stations with respect to each other, and accordingly determine the position of another wireless device relative to the anchor stations, as described above with reference to FIGS. 1-5. Any one of these functionalities may be partially (or entirely) implemented in hardware and/or on the processor unit 602. For example, the functionality may be implemented with an application specific integrated circuit, in logic implemented in the processor unit 602, in a co-processor on a peripheral device or card, etc. Further, realizations may include fewer or additional components not illustrated in FIG. 6 (e.g., video cards, audio cards, additional network interfaces, peripheral devices, etc.). The processor unit 602, the memory unit 606, and the network interfaces 606 are coupled to the bus 610. Although illustrated as being coupled to the bus 610, the memory unit 606 may be coupled to the processor unit 602.

While the embodiments are described with reference to various implementations and exploitations, it will be understood that these embodiments are illustrative and that the scope of the inventive subject matter is not limited to them. In general, techniques for determining relative position of a wireless device in a wireless communication network as described herein may be implemented with facilities consistent with any hardware system or hardware systems. Many variations, modifications, additions, and improvements are possible.

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A method comprising:
determining, at a first reference wireless network device of a plurality of wireless network devices of a wireless communication network, to calculate a relative position of a target wireless network device of the plurality of wireless network devices;
selecting a subset of the plurality of wireless network devices as reference wireless network devices based, at least in part, on determining one or more performance measurements associated with at least the subset of the plurality of wireless network devices;
determining a position of each of the reference wireless network devices relative to each other based, at least in part, on a distance between each pair of the reference wireless network devices; and
determining the relative position of the target wireless network device relative to the reference wireless network devices based, at least in part, on the position of each of the reference wireless network devices relative to each other and a distance between the target wireless network device and each of the reference wireless network devices.

2. The method of claim 1, wherein said selecting the subset of the plurality of wireless network devices as reference wireless network devices based, at least in part, on determining the one or more performance measurements associated with at least the subset of the plurality of wireless network devices comprises:
selecting the subset of the plurality of wireless network devices as reference wireless network devices based, at least in part, on at least one of comparing a received signal strength indicator (RSSI) associated with each of the subset of the plurality of wireless network devices to an RSSI threshold and comparing a packet error rate (PER) associated with each of the subset of the plurality of wireless network devices to a PER threshold.

3. The method of claim 1, wherein, in response to said determining to calculate the relative position of the target wireless network device, the method further comprises:
for each of the plurality of wireless network devices of the wireless communication network,
transmitting a control message from the first reference wireless network device to the wireless network device;
receiving a response message from the wireless network device at the first reference wireless network device; and
determining the one or more performance measurements associated with the wireless network device based, at least in part, on said receiving the response message from the wireless network device.

4. The method of claim 1, wherein said selecting the subset of the plurality of wireless network devices as the reference wireless network devices based, at least in part, on determining the one or more performance measurements further comprises:
for each of the plurality of wireless network devices,
comparing the one or more performance measurements associated with the wireless network device against one or more corresponding performance measurement thresholds;
determining whether the one or more performance measurements associated with the wireless network device are in accordance with the one or more corresponding performance measurement thresholds based on said comparing the one or more performance measurements associated with the wireless network device against the one or more corresponding performance measurement thresholds; and
determining not to designate the wireless network device as one of the reference wireless network devices, in response to determining that the one or more performance measurements associated with the wireless network device are not in accordance with the one or more corresponding performance measurement thresholds.

5. The method of claim 4, wherein:
for each of the plurality of wireless network devices, determining to designate the wireless network device as one of the reference wireless network devices, in response to determining that one or more performance measurements associated with the wireless network device are in accordance with the one or more corresponding performance measurement thresholds.

6. The method of claim 4, wherein:
for each of the plurality of wireless network devices, in response to determining that the one or more performance measurements associated with the wireless network device are in accordance with the one or more corresponding performance measurement thresholds:
determining whether the wireless network device is in line of sight of the first reference wireless network device;
determining not to designate the wireless network device as one of the reference wireless network devices, in response to determining that the wireless network device is not in line of sight of the first reference wireless network device; and
determining to designate the wireless network device as one of the reference wireless network devices, in response to determining that the wireless network device is not in line of sight of the first reference wireless network device.

7. The method of claim 1, wherein the one or more performance measurements comprise a signal strength and wherein said selecting the subset of the plurality of wireless network devices as the reference wireless network devices based, at least in part, on determining the one or more performance measurements associated with at least the subset of the plurality of wireless network devices further comprises:
determining the signal strength associated with each of at least the subset of the plurality of wireless network devices with reference to the first reference wireless network device;
selecting, as a second reference wireless network device, one of at least the subset of the plurality of wireless network devices that is associated with a highest signal strength with reference to the first reference wireless network device;
causing the second reference wireless network device to determine the signal strength associated with each of at least a remaining of the subset of the plurality of wireless network devices with reference to the second reference wireless network device; and
selecting, as a third reference wireless network device, one of at least the remaining of the subset of the plurality of wireless network devices that is associated with a highest signal strength with reference to the first reference wireless network device and with reference to the second reference wireless network device.

8. The method of claim 1, wherein, in response to selecting three reference wireless network devices, said determining the position of each of the reference wireless network devices relative to each other based, at least in part, on a distance between each pair of the reference wireless network devices comprises:
determining a first distance between the first reference wireless network device and a second reference wireless network device of the plurality of wireless network devices;
determining a second distance between the first reference wireless network device and a third reference wireless network device of the plurality of wireless network devices;
determining a third distance between the second reference wireless network device and the third reference wireless network device; and
calculating the position of the first reference wireless network device, the second reference wireless network device, and the third reference wireless network device relative to each other based, at least in part, on the first distance, the second distance, and the third distance.

9. The method of claim 1, wherein the first reference wireless network device is associated with a first class of wireless network devices and wherein said selecting the subset of the plurality of wireless network devices as reference wireless network devices further comprises:
selecting the subset of the plurality of wireless network devices as reference wireless network devices based, at least in part, on determining that the subset of the plurality of wireless network devices are associated with the first class of wireless network devices and determining the one or more performance measurements associated with at least the subset of the plurality of wireless network devices.

10. A method comprising:
determining, at a first reference wireless network device of a plurality of wireless network devices of a wireless communication network, to calculate a relative position of a target wireless network device of the plurality of wireless network devices;
selecting a subset of the plurality of wireless network devices as potential reference wireless network devices based, at least in part, on determining one or more performance measurements associated with at least the subset of the plurality of wireless network devices;
selecting a predetermined number of reference wireless network devices from the potential reference wireless network devices based, at least in part, on determining line of sight visibility from the potential reference wireless network devices to the first reference wireless network device;
determining a position of each of the reference wireless network devices relative to each other based, at least in part, on a distance between each pair of the reference wireless network devices; and
determining the relative position of the target wireless network device relative to the reference wireless network devices based, at least in part, on the position of each of the reference wireless network devices relative to each other and a distance between the target wireless network device and each of the reference wireless network devices.

11. The method of claim 10, wherein said selecting the subset of the plurality of wireless network devices as the potential reference wireless network devices based, at least in part, on determining the one or more performance measurements associated with at least the subset of the plurality of wireless network devices comprises:
selecting the subset of the plurality of wireless network devices as potential reference wireless network devices based, at least in part, on at least one of comparing a received signal strength indicator (RSSI) associated with each of the subset of the plurality of wireless network devices to an RSSI threshold and comparing a packet error rate (PER) associated with each of the subset of the plurality of wireless network devices to a PER threshold.

12. The method of claim 10, wherein said selecting the subset of the plurality of wireless network devices as the potential reference wireless network devices based, at least in part, on determining the one or more performance measurements further comprises:
for each of the plurality of wireless network devices,
comparing the one or more performance measurements associated with the wireless network device against one or more corresponding performance measurement thresholds;
determining whether the one or more performance measurements associated with the wireless network device are in accordance with the one or more corresponding performance measurement thresholds based on said comparing the one or more performance measurements associated with the wireless network device against the one or more corresponding performance measurement thresholds;
determining not to designate the wireless network device as one of the potential reference wireless network devices, in response to determining that the one or more performance measurements associated with the wireless network device are not in accordance with the one or more corresponding performance measurement thresholds; and
determining to designate the wireless network device as one of the potential reference wireless network devices, in response to determining that the one or more performance measurements associated with the wireless network device are in accordance with the one or more corresponding performance measurement thresholds.

13. The method of claim 10, wherein said selecting the predetermined number of reference wireless network devices from the potential reference wireless network devices based, at least in part, on determining line of sight visibility from the potential reference wireless network devices to the first reference wireless network device comprises:
for each of the potential reference wireless network devices:
determining whether the potential reference wireless network device is in line of sight of the first reference wireless network device;
determining not to designate the potential reference wireless network device as one of the reference wireless network devices, in response to determining that the potential reference wireless network device is not in line of sight of the first reference wireless network device; and
determining to designate the potential reference wireless network device as one of the reference wireless network devices, in response to determining that the potential reference wireless network device is not in line of sight of the first reference wireless network device.

14. One or more machine-readable storage media having instructions stored therein, which when executed by one or more processors causes the one or more processors to perform operations that comprise:
determining, at a first reference wireless network device of a plurality of wireless network devices, to calculate a relative position of a target wireless network device of the plurality of wireless network devices;
selecting a subset of the plurality of wireless network devices as reference wireless network devices based, at least in part, on determining one or more performance measurements associated with at least the subset of the plurality of wireless network devices;
determining a position of each of the reference wireless network devices relative to each other based, at least in part, on a distance between each pair of the reference wireless network devices; and
determining the relative position of the target wireless network device relative to the reference wireless network devices based, at least in part, on the position of each of the reference wireless network devices relative to each other and a distance between the target wireless network device and each of the reference wireless network devices.

15. The machine-readable storage media of claim 14, wherein said operation of selecting the subset of the plurality of wireless network devices as reference wireless network devices based, at least in part, on determining the one or more performance measurements associated with at least the subset of the plurality of wireless network devices comprises:
selecting the subset of the plurality of wireless network devices as reference wireless network devices based, at least in part, on at least one of comparing a received signal strength indicator (RSSI) associated with each of the subset of the plurality of wireless network devices to an RSSI threshold and comparing a packet error rate (PER) associated with each of the subset of the plurality of wireless network devices to a PER threshold.

16. The machine-readable storage media of claim 14, wherein said operation of selecting the subset of the plurality of wireless network devices as the reference wireless network devices based, at least in part, on determining the one or more performance measurements further comprises:
for each of the plurality of wireless network devices,
comparing the one or more performance measurements associated with the wireless network device against one or more corresponding performance measurement thresholds;
determining whether the one or more performance measurements associated with the wireless network device are in accordance with the one or more corresponding performance measurement thresholds based on said operation of comparing the one or more performance measurements associated with the wireless network device against the one or more corresponding performance measurement thresholds; and
determining not to designate the wireless network device as one of the reference wireless network devices, in response to determining that the one or more performance measurements associated with the wireless network device are not in accordance with the one or more corresponding performance measurement thresholds.

17. The machine-readable storage media of claim 16, wherein the operations further comprise:
for each of the plurality of wireless network devices, in response to determining that the one or more performance measurements associated with the wireless network device are in accordance with the one or more corresponding performance measurement thresholds:
determining whether the wireless network device is in line of sight of the first reference wireless network device;
determining not to designate the wireless network device as one of the reference wireless network devices, in response to determining that the wireless network device is not in line of sight of the first reference wireless network device; and
determining to designate the wireless network device as one of the reference wireless network devices, in response to determining that the wireless network device is not in line of sight of the first reference wireless network device.

18. A wireless network device comprising:
a processor;
a reference station selection unit coupled with the processor, the reference station selection unit operable to:
determine, at the wireless network device of a plurality of wireless network devices of a wireless communication network, to calculate a relative position of a target wireless network device of the plurality of wireless network devices;
select a subset of the plurality of wireless network devices as reference wireless network devices based, at least in part, on the reference station selection unit determining one or more performance measurements associated with at least the subset of the plurality of wireless network devices, wherein the wireless network device is selected as one of the reference wireless network devices; and
a relative position calculation unit coupled with the processor, the relative position calculation unit operable to:
determine a position of each of the reference wireless network devices relative to each other based, at least in part, on a distance between each pair of the reference wireless network devices; and
determine the relative position of the target wireless network device relative to the reference wireless network devices based, at least in part, on the position of each of the reference wireless network devices relative to each other and a distance between the target wireless network device and each of the reference wireless network devices.

19. The wireless network device of claim 18, wherein the reference station selection unit operable to select the subset of the plurality of wireless network devices as the reference wireless network devices based, at least in part, on determining the one or more performance measurements further comprises the reference station selection unit operable to:
for each of the plurality of wireless network devices,
compare the one or more performance measurements associated with the wireless network device against one or more corresponding performance measurement thresholds;
determine whether the one or more performance measurements associated with the wireless network device are in accordance with the one or more corresponding performance measurement thresholds based on the reference station selection unit comparing the one or more performance measurements associated with the wireless network device against the one or more corresponding performance measurement thresholds; and
determine not to designate the wireless network device as one of the reference wireless network devices, in response to the reference station selection unit determining that the one or more performance measurements associated with the wireless network device are not in accordance with the one or more corresponding performance measurement thresholds.

20. The wireless network device of claim 19, wherein the reference station selection unit is further operable to:
for each of the plurality of wireless network devices, determine to designate the wireless network device as one of the reference wireless network devices, in response to the reference station selection unit determining that one or more performance measurements associated with the wireless network device are in accordance with the one or more corresponding performance measurement thresholds.

21. The wireless network device of claim 19, wherein
for each of the plurality of wireless network devices, in response to the reference station selection unit determining that the one or more performance measurements associated with the wireless network device are in accordance with the one or more corresponding performance measurement thresholds, the reference station selection unit is further operable to:
determine whether the wireless network device is in line of sight of the first reference wireless network device;
determine not to designate the wireless network device as one of the reference wireless network devices, in response to the reference station selection unit determining that the wireless network device is not in line of sight of the first reference wireless network device; and
determine to designate the wireless network device as one of the reference wireless network devices, in response to the reference station selection unit determining that the wireless network device is not in line of sight of the first reference wireless network device.

22. The wireless network device of claim 18, wherein the wireless network device is associated with a first class of wireless network devices and wherein the reference station selection unit operable to select the subset of the plurality of wireless network devices as reference wireless network devices further comprises the reference station selection unit operable to:
select the subset of the plurality of wireless network devices as reference wireless network devices based, at least in part, on the reference station selection unit determining that the subset of the plurality of wireless network devices are associated with the first class of wireless network devices and the reference station selection unit determining the one or more performance measurements associated with at least the subset of the plurality of wireless network devices.
